(19) United States
(12) Patent Application Publication
(10) Pub. No.: US 2007/0165263 A1
(43) Pub. Date: Jul. 19, 2007

(54) Image Processing Apparatus and Image Processing Program for Superimposing an Image

(75) Inventor: Tetsuya Suzuki, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/622,936

(22) Filed: Jan. 12, 2007

(30) Foreign Application Priority Data
Jan. 18, 2006 (JP) 2006-009657

(51) Int. Cl. G06K 15/00

(52) U.S. Cl. 358/1.14; 358/540

(57) ABSTRACT

An image processing apparatus for generating a synthesized image in which an auxiliary image is superimposed on a normal image, includes an image data synthesizing unit to which normal image data comprising color information and image attribute information correspondent to pixels bitmap-expanded from the normal image and auxiliary image data comprising at least color information correspondent to pixels bitmap-expanded from the auxiliary image are supplied, and which generates synthesized image data for each pixel by synthesizing pixel data of the normal image data and pixel data of the auxiliary image data based on the color information and image attribute information of the normal image data.

### CROSS-REFERENCE TO RELATED APPLICATIONS

This application is based upon and claims the benefit of priority from the prior Japanese Patent Application No. 2006-009657, filed on Jan. 18, 2006, the entire contents of which are incorporated herein by reference.

### BACKGROUND OF THE INVENTION

1. Field of the Invention

The present invention relates to an image processing apparatus and an image processing program for superimposing an image, and more particularly to an image processing apparatus for superimposing an auxiliary image such as latent image or background image according to the image attributes and so on of a normal image, and to a program for the same.

2. Description of the Related Art

Image forming apparatuses for superimposingly printing a latent image comprising a copy-inhibiting pattern on a normal image in order to inhibit the illegal copy of confidential documents have been proposed in recent years. In these image forming apparatuses, when set by either a host computer side or the image forming apparatus side, a latent image, which has a copy-inhibiting pattern (for example a “copy prohibited” or “copy” design) which is inconspicuous in the printed state and is conspicuous after copying is superimposingly printed on a normal image produced by an application program or the like. An image forming apparatus of this kind is described in, for example, Japanese Patent Application Laid-open No. 2001-197297.

In addition, image forming apparatuses for superimposingly printing a background image such as “secret” or “draft” or “EPSON PROPRIETARY” known as forms on a normal image have also been proposed and are gaining widespread use.

In these image forming apparatuses for superimposingly printing an auxiliary image such as a latent image or background image on a normal image, print data described in a specified page description language (PDL) from the host computer is received, and designated auxiliary images are superimposed and bitmap-expanded at a stage at which this specified PDL described print data is expanded to bitmap data. This bitmap-expansion is executed using a specific renderer with the capacity to deal with the specified page description language noted above.

In the image forming apparatuses for superimposing of an auxiliary image on a normal image described above it is usual for the normal image to be overwritten on the auxiliary image, a text character image region, a graphic image region and a picture image region of a normal image being respectively overwritten on a latent image or background image. Accordingly, no auxiliary image is formed between the text characters of the text character image region, therefore, it is undesirable because of the reduction in the auxiliary image region in a case of copy-inhibiting pattern latent images. Furthermore, in background images as well, the absence of background image display by overwriting is sometimes undesirable.

An added inherent problem pertains to the fact that, at the stage where a specified PDL described print data is expanded to bitmap data, because the auxiliary image is superimposed by a specific renderer for dealing with this PDL, auxiliary images cannot be superimposed on print data described in any other PDL language.

### SUMMARY OF THE INVENTION

Thereupon, an object of the present invention lies in the provision of an image processing apparatus that can generate image data obtained by desired superimposing of a normal image and an auxiliary image according to the type of normal image, and a program for the same.

A further object of the present invention lies in the provision of an image processing apparatus that can generate image data on which an auxiliary image is superimposed for print data written in any page description language, and a program for the same.

A first aspect of the present invention for achieving the objects described above pertains to an image processing apparatus for generating a synthesized image in which an auxiliary image is superimposed on a normal image, comprising: an image data synthesizing unit to which normal image data comprising color information and image attribute information correspondent to pixels bitmap-expanded from the normal image and auxiliary image data comprising at least color information correspondent to pixels bitmap-expanded from the auxiliary image are supplied, and which generates synthesized image data for each pixel by synthesizing pixel data of the normal image data and pixel data of the auxiliary image data based on the color information and image attribute information of the normal image data.

In a preferred mode of the first aspect described above, the image data synthesizing unit synthesizes the two data by substituting the color information of the auxiliary image data for the color information of the normal image data in a case that a combination of the color information and image attribute information of the normal image data is a first combination, and without substituting the color information of the auxiliary image data for the color information of the normal image data in a case that a combination of the color information and image attribute information of the normal image data is a second combination.

In a preferred mode of the first aspect described above, The image data synthesizing unit synthesizes the two data by blend-processing the color information of the normal image data and the color information of the auxiliary image data in a predetermined blending ratio in a case that a combination of the color information and image attribute information of the normal image data is a first combination, and without substituting the color information of the auxiliary image data for the color information of the normal image data in a case that a combination of the color information and image attribute information of the normal image data is a second combination.

A second aspect of the present invention for achieving the objects described above pertains to an image forming apparatus for printing a synthesized image in which an auxiliary image is superimposed on a normal image, comprising: an image processing unit comprising a renderer which generates normal image data comprising color information and image attribute information correspondent to pixels bitmap-expanded from the normal image based on normal image print data described in a predetermined print language, and an image data synthesizing unit to which auxiliary image data comprising at least color information correspondent to pixels bitmap-expanded from the auxiliary image and the normal image data are supplied, and which generates synthesized image data for each pixel by synthesizing pixel data of the normal image data and pixel data of the auxiliary image data; and a print engine which prints images based on the synthesized image data generated by the image processing unit.

### BRIEF DESCRIPTION OF THE DRAWINGS

FIG. 1 is a diagram showing an example of a normal image, an auxiliary image and a synthesized image thereof;

FIG. 2 is a diagram showing an example of a normal image, an auxiliary image and a synthesized image thereof of a first embodiment;

FIG. 3 is a diagram showing an example of a normal image, an auxiliary image and a synthesized image thereof of the first embodiment;

FIG. 4 is a schematic diagram of an image forming system of the present embodiment;

FIG. 5 is a flow chart of the rendering processing of the present embodiment;

FIG. 6 is a flow chart of the synthesizing processing of the bitmap data synthesizing unit of the first embodiment;

FIG. 7 is a diagram showing an example of data in a buffer memory produced by bitmap data synthesizing processing;

FIG. 8 is a schematic diagram of the bitmap data synthesizing unit of the present embodiment;

FIG. 9 is another schematic diagram of the bitmap data synthesizing unit of the present embodiment; and

FIG. 10 is a diagram of an example of the synthesizing of image data of a second embodiment.

### DESCRIPTION OF THE PREFERRED EMBODIMENTS

The embodiments of the present invention will be described hereinafter with reference to the drawings. However, the technical scope of the present invention should not be regarded as being restricted to these embodiments and extends to those matters described in the scope of the claims or their equivalents.

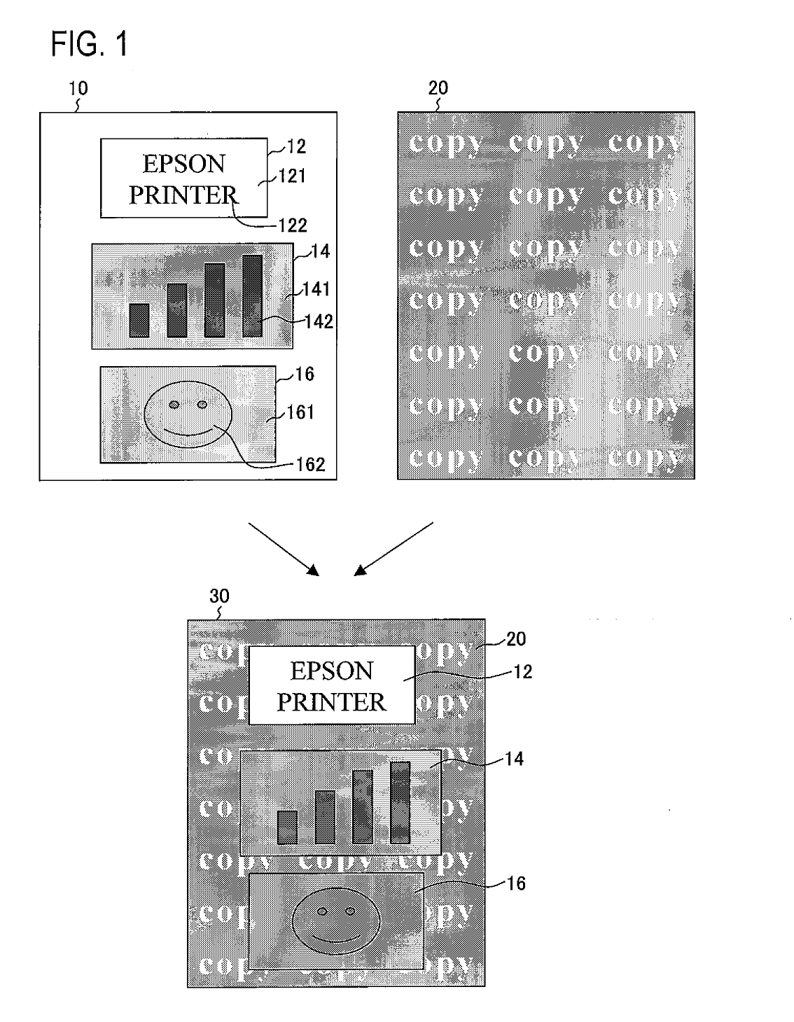

FIG. 1 shows an example of a normal image, an auxiliary image and a synthesized image thereof. A normal image 10 comprises text characters 12, a graphic 14 such as a figure or graph, and picture image 16 such as a photograph or picture or an illustration. The print data of the characters includes data pertaining to what characters should be drawn in what position in what size, color and pattern, a bitmap-expanded character image 12 being generated by drawing of a text character image 122 in a character image region 121 by a renderer of an image processing apparatus. In addition, the print data of the graphic includes data pertaining to what figures should be drawn in what position in what size, color and pattern, a bitmap-expanded graphic image 14 being generated by drawing of a figure image 142 in a graphic image region 141 by a renderer. In addition, the image data of the picture includes data pertaining to what position and in what size bitmap-expanded picture images 161, 162 should be drawn, the renderer generating the picture image 16 without altering these picture images.

On the other hand, an auxiliary image 20 constitutes a latent image comprising a pattern or design for inhibiting, for example, the illegal copy of a document, and in the example of FIG. 1 the auxiliary image is an image in which a plurality of text characters that read the word “copy” are stamped on a predetermined color base. This auxiliary image 20 is stored in advance in either a printer of an image forming apparatus or in a host computer auxiliary to a printer driver as bitmap data or as bitmap-expandable intermediate code data.

As in common conventional synthesizing methods, a synthesized image 30 is configured by overwriting of the text character image 12, the graphic image 14 and the picture image 16 on the auxiliary image 20 serving as the latent image. That is to say, the normal image 10 is drawn as a result of overwriting of each of the text character image 12, the graphic image 14 and the picture image 16 on the base color of a print paper. This drawing processing is based on, for example, generation of an intermediate code from print data written in a predetermined print language supplied from the host computer, and overwrite processing of the images 12, 14, 16 being performed in accordance with this intermediate code. Accordingly, similarly to the drawing processing described above, the synthesizing of the auxiliary image 20 involves a buffer memory being initialized by latent image data, and each of the text character image 12, graphic image 14 and picture image 16 being overwritten on the buffer memory.

As a result, in the synthesized image 30 the latent image 20 is not drawn on either of the text character image 12, the graphic image 14 or the picture image 16. The overwriting or blend processing of the latent image 20 on the picture image 16 or a specific graphic image 14 is undesirable. However, from the viewpoint of increasing the area over which the latent image is drawn in order to enhance the illegal copy-inhibiting effect it is preferable that the latent image 20 be drawn on the character image region 121 of the character image 12 other than the text character image 122. However, when a simple overwriting alone is performed, as in the synthesized image 30, the latent image 20 is not drawn in the base color region 121 between the text characters of the character image 12. In addition, in the graphic image 14 as well in which there is the base color region 141 and the figure region 142, it is sometimes preferable, depending on the color thereof, for the latent image 20 to be drawn on the base color region 141.

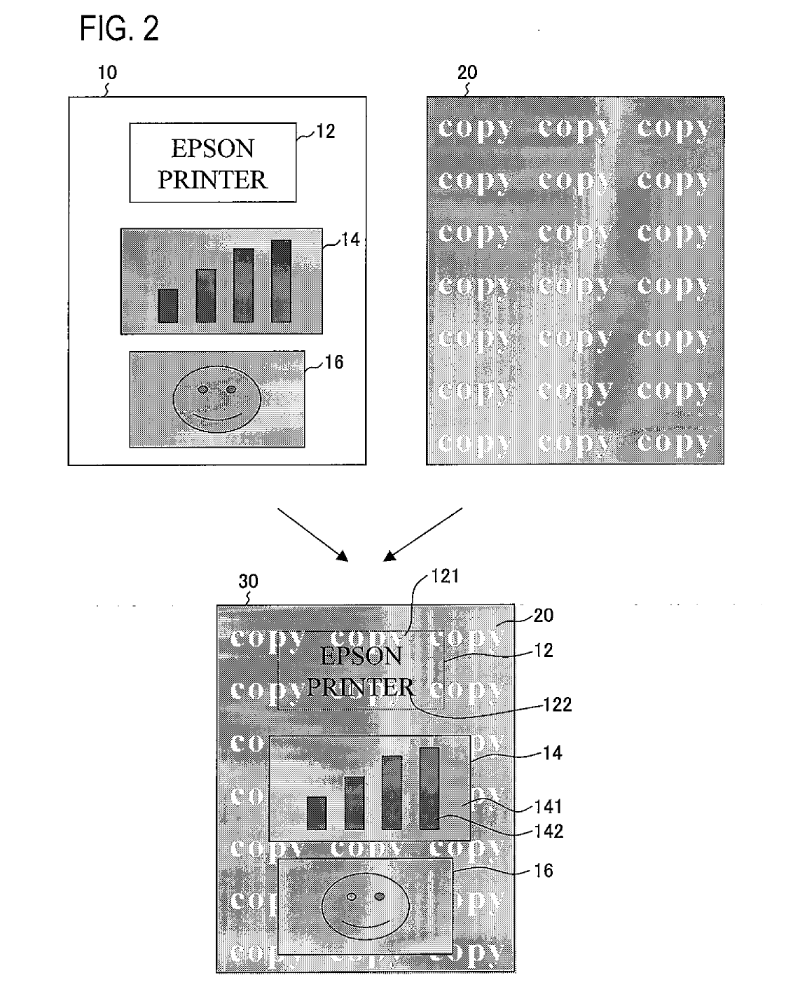

FIG. 2 is a diagram showing an example of a normal image, an auxiliary image and a synthesized image thereof of a first embodiment. While the normal image 10 and auxiliary image 20 are identical to those of FIG. 1, in the synthesized image 30 the auxiliary image 20 is drawn on the base color character region 121 of the character image 12, and the graphic image 14 and picture image 16 are overwritten on the auxiliary image 20. In other words, the latent image 20 is also drawn in the character region 121 other than the text character image 122, and the “copy” design is provided across a wider region.

Furthermore, the latent image 20 may also be drawn in the base color region 141 of the graphic image 14 other than the FIG. 142. However, because specified color information is also supplied to the base color region 141 of the graphic image 14, it is sometimes undesirable when the latent image 20 is drawn for a visually conspicuous “copy” design to be formed on the graphic image 14 itself. Thereupon, the auxiliary image 20 is unlikely to be visually conspicuous if drawn when, for example, the color of the base color region 141 of the graphic image 14 is the color of the latent image 20 or a color near thereto, and in some instances this is not inappropriate.

As the picture image 16 constitutes bitmap data in which there is a lack of pixel color information uniformity, the drawing of a latent image on the picture image 16 is not regarded as being appropriate.

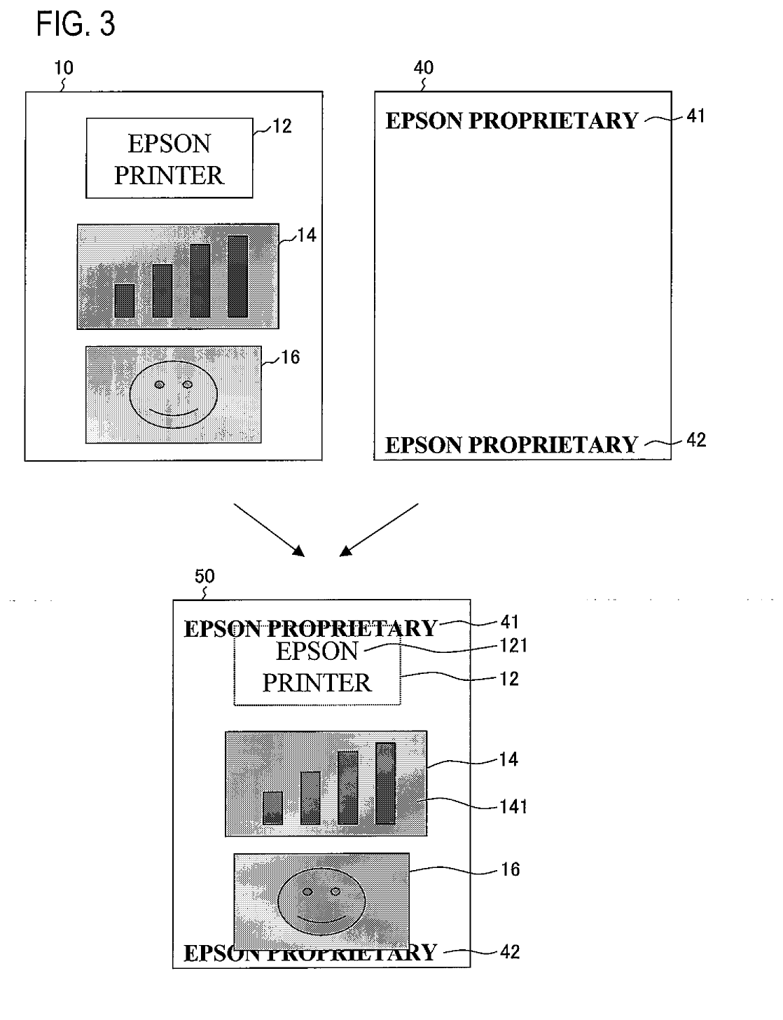

FIG. 3 is a diagram showing an example of a normal image, an auxiliary image and a synthesized image of the first embodiment. While the normal image 10 is identical to that of FIG. 1 and FIG. 2, the embodiment comprises an auxiliary image 40 serving as a background image comprising an “EPSON PROPRIETARY” pattern 41, 42 above and below. While there is little difference in visual characteristics between the image printed state and the copied state of a background image not similarly to a latent image, they are synthesized in the normal image and printed similarly to a latent image.

In a synthesized image 50 of the normal image and background image of FIG. 3 the normal image character image 12, graphic image 14 and picture image 16 are not fully overwritten on the background image, and a background image pattern 41 is drawn on the base color region 121 which constitutes the character image region of the character image 12. On the other hand, a background image pattern 42 is not drawn on the picture image 16. Thereupon, for the graphic image 14, the graphic image 14 may be overwritten, or the background image may be drawn on the base color region 141 of the graphic image, similarly to the latent image as described above.

To form the synthesized images shown in FIG. 2 and FIG. 3, the bitmap data synthesizing unit of the image processing apparatus of this embodiment judges which of the normal image or the auxiliary image is to be overwritten or blend-processed in accordance with the color information and image attribute information combination contained in the pixel data of the normal image and draws a synthesized image of these two images.

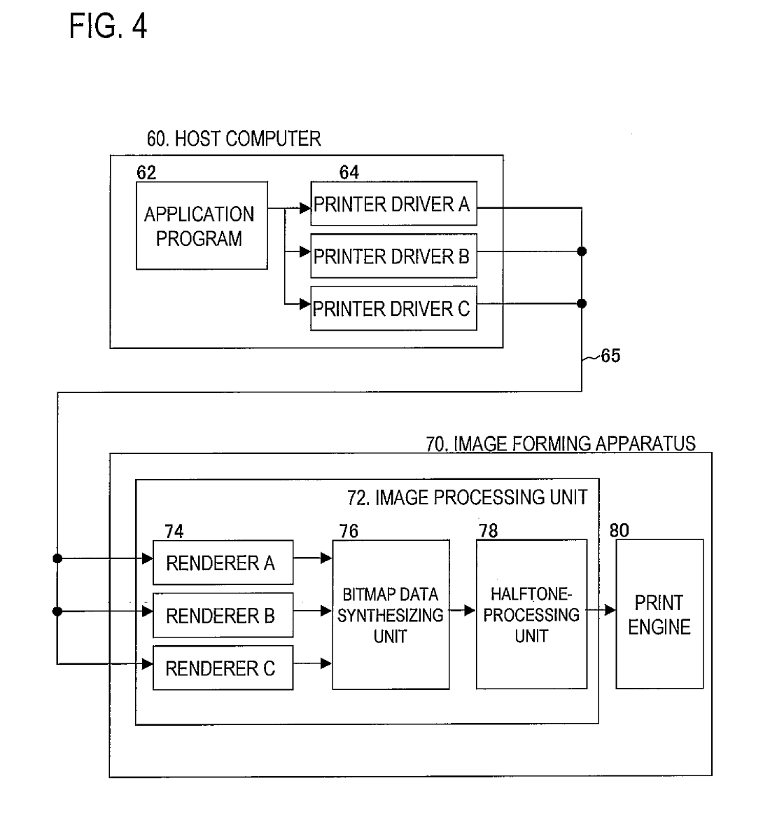

FIG. 4 is a schematic diagram of an image forming system of the present embodiment. Print data 65 described in a predetermined page description language (PDL) is output from a host computer 60, and image formation is performed by an image forming apparatus 70 such as a printer subsequent to the receipt of this print data 65. An application program 62 and a printer driver 64 are installed in the host computer 60, a normal image generated by the application program 62 being supplied to the printer driver 64, and the print data 65 for forming the normal image being generated by the printer driver 64. The printer driver 64 comprises, for example, three types of driver, the printer driver being selected on the basis of selection by the user, and the print data being described by a PDL correspondent to the selected printer driver.

The image forming apparatus 70 comprises an image processing unit 72 and a print engine 80. The image processing unit 72 comprises a plurality of renderers 74 that correspond to the print data PDL types, a bitmap data synthesizing unit 76 for synthesizing normal image data bitmap-expanded by the renderers and auxiliary image data bitmap-expanded by the renderers or stored in advance in the memory of the image processing unit, and a halftone-processing unit 78 for halftone-processing the synthesized image data to generate multi-gradated image formable gradated data. The print engine 80 prints the synthesized image using this halftone-processed gradated data.

The image processing unit 72 can be configured from a processor unit and a program memory in which an image processing program is stored, and a primary storage memory. Or the image processing unit 72 can instead be configured from a renderer configured from a processor unit and a rendering program, and a bitmap data synthesizing unit 76 and halftone-processing unit 78 configured from a special hardware circuit. Furthermore, all image processing unit 72 configurations can be configured from a special hardware circuit and a control circuit for controlling the same.

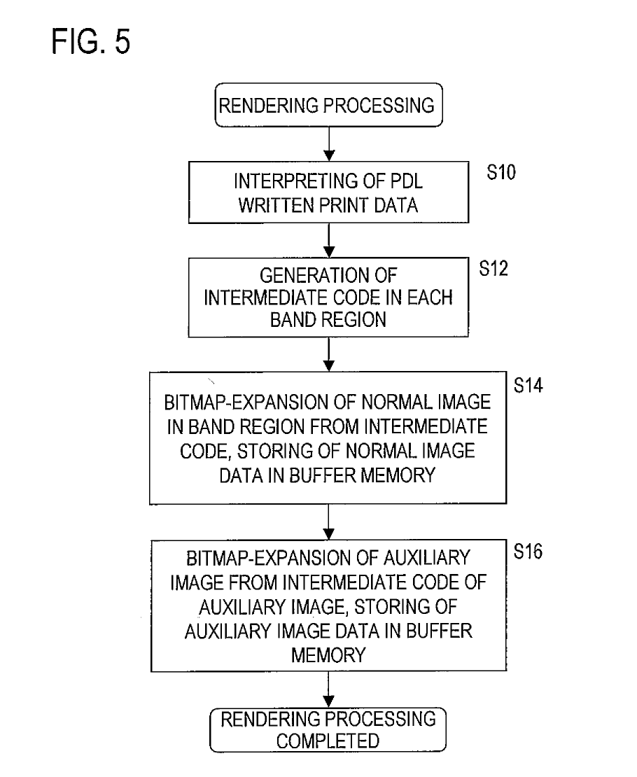

FIG. 5 is a flow chart of the rendering processing of the present embodiment. The renderer 74 interprets the print data described by the specified PDL (S10) and for each band region generates an intermediate code for bitmap-expanding the normal image requested by the print data (S12). The band region constitutes a region formed by partitioning of the printing plane in plurality. Thereupon, the normal image is bitmap-expanded in each band region of the buffer memory from this intermediate code (S14). As a result, the bitmap-expanded normal image data is stored in the buffer memory.

This bitmap-expanded image data comprises color information and image attribute information for each pixel. The color information constitutes, in the case of a color, 8-bit gradated data for RGB respectively or 8-bit gradated data for CMYK respectively. In addition, image attribute information constitutes attribute data for identifying if an image is a character image, a graphic image or a picture image. Image attribute information is utilized for, for example, screen selection in halftone processing. In addition, image attribute information is sometimes utilized for selection of color conversion tables, and a specific description of this image data will be given later.

Next, the renderer 74 bitmap-expands the auxiliary image from the intermediate code of the auxiliary image stored in the memory of the image processing unit 72, and stores the auxiliary image data of each expanded pixel in the buffer memory (S16). The auxiliary image data comprises, for example, color information for each pixel. There is no particular need for image attribute information to be contained in the auxiliary image data. However, image attribute information may be contained on the auxiliary image when a special halftone-processing or the like is performed thereon.

The rendering processing described above is performed by either of the renderers A, B or C correspondent to the print data PDL supplied from the host computer 60. However, the processing performed by each of the renderers results in the normal image data and auxiliary image data being bitmap-expanded and stored in the buffer memory. Accordingly, the renderers are correspondable with any PDL described print data from the host computer side.

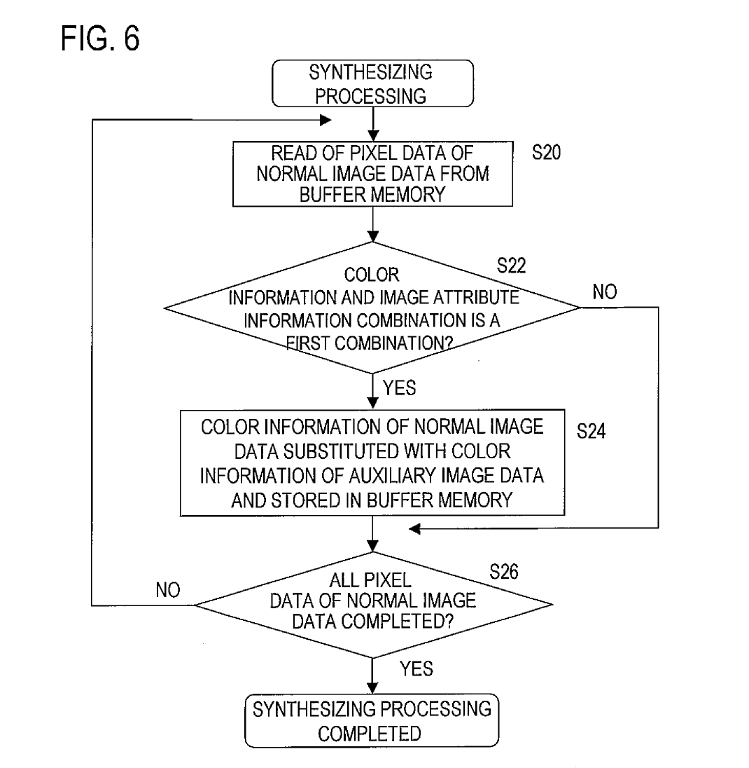

FIG. 6 is a flow chart of the synthesizing processing of the bitmap data synthesizing unit of the present embodiment. The synthesizing unit 76 reads the pixel data of the normal image data stored in the buffer memory (S20), and checks whether the combination of the color information and image attribute information of the red pixel data constitutes a first combination or not (S22). Here, the first combination denotes either a combination in which the color information is white or a color close thereto and the image attribute information is a graphic, or to a combination in which the color information is the same color as the auxiliary image or a color close thereto and the image attribute information is a graphic, or both of them.

If the color information and image auxiliary information combination is the first combination (YES of S22), the color information of the normal image data is substituted by the color information of the auxiliary image data and stored in the buffer memory (S24). In other words, corresponding pixel color information of the auxiliary image data is overwritten in the buffer memory in which the normal image data is stored. The processings S20 to S24 described above are repeated on all pixel data of the normal image data (NO of S26). When the processings on all pixel data have been completed, the synthesized image data in the buffer memory of the normal image data is bitmap-expanded. Following this, the synthesized image data is converted to image forming gradated data by halftone-processing by the halftone-processing unit 78 and provided to the print engine 80.

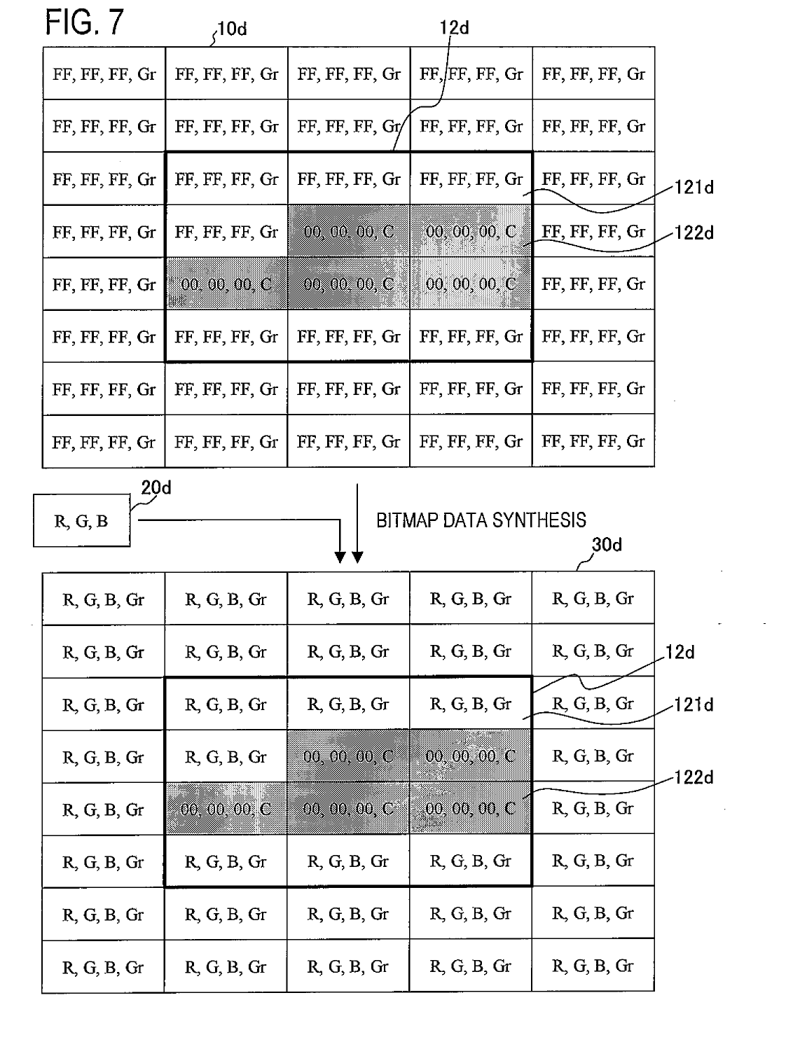

FIG. 7 is a diagram of an example of buffer memory data produced by bitmap data synthesizing processing. The diagram shows an example of normal image data 10d, auxiliary image data 20d and synthesized image data 30d. The normal image data 10d and synthesized image data 30d comprise a plurality of pixel data, and the pixel data comprises RGB color information and image attribute information of each of graphic Gr, character C and picture I. The RGB color information consists of 8-bit data respectively (FF, OO and so on in a hexadecimal notation representation), the (FF, FF, FF) corresponding to white and the (OO, OO, OO) corresponding to black. For CMY, which has a complementary color relationship with RGB, the white and black are reversed.

The normal image data 10d shown in FIG. 7 constitutes pixel data of white (FF, FF, FF) and graphic Gr for the base color pixel. Character image data 12d is configured by the arrangement of text character pixel data 122d in base color pixel data 121d. The white (FF, FF, FF) and graphic Gr pixel data are written to execute the buffer memory initializing processing of the rendering processing explained by FIG. 5. Following this, the pixel data of the image correspondent to the intermediate code is overwritten in the buffer memory. As a result, the character C data is overwritten by black (OO, OO, OO) in the normal image data 10d of FIG. 7 only on the pixels from which the text characters are configured.

The pixel data of the auxiliary image data 20d comprises color information R, G, B and does not comprise image attribute information. While the color information RGB constitutes color information for each pixel for forming the auxiliary image design or pattern, it is not shown specifically in FIG. 7, but instead is indicated simply by RGB.

When the pixel data of the normal image data 10d corresponds with the first combination, the color information of this pixel data is substituted by and overwritten by the color information of the pixel data of the auxiliary image data 20d by the synthesizing processing explained in FIG. 6. As a result, the pixel data comprising the white (FF, FF, FF) and graphic Gr of the normal image data 10d of the synthesized image data 30d is converted to pixel data comprising the auxiliary image color data RGB and graphic Gr. Besides the initialized pixels of the normal image data 10d, the base color region image data 121d of the character image data 12d is also substituted by the auxiliary image color data RGB.

As shown in FIG. 2 and FIG. 3, when image forming is performed in accordance with this synthesized image data 30d, the auxiliary image is also drawn on the pixels (in the region 121) other than the text characters 122 of the character image 12.

In addition, the first combination explained by the synthesizing processing of FIG. 6 was explained as also including an example of a combination in which the color information is the same color as the auxiliary image or a color close thereto and the image attribute information is a graphic. In this case, the base color region 141 of the graphic image 14 of FIG. 2 and FIG. 3 is substituted by the auxiliary image color information when it is the same color of the auxiliary image, or more particularly the latent image or a color close thereto. As a result, the auxiliary image is also drawn in the base color region 141 of the graphic image 14. Because the design or pattern of the auxiliary image is visually not conspicuous in the image formed state when it is the same color, whatever auxiliary image is drawn in the graphic image 14 will not be inappropriate. The auxiliary image becomes visually conspicuous upon being copied, in other words it is image formed due to the higher output density difference. Consequently, as a pattern for inhibiting illegal copy, it is preferably formed across a broad region.

In FIG. 7, the image data of the normal image data 10d of a second combination different from the first combination described above is not overwritten on the color data of the auxiliary image data 20d. Accordingly, the image data 122d of the black (OO, OO, OO) and the character C is not converted and remains unchanged on the synthesized image data 30d.

The synthesizing processing of the embodiment described above involves a synthesizing bitmap-expanded normal image data and auxiliary image data, based on a determining, by a pixel unit, of which images are to be overwritten in accordance with a normal image data color information and image attribute information combination. Accordingly, the region in which the auxiliary image is drawn can be flexibly converted in pixel units rather than image units. As a consequence, more appropriate synthesized image data can be generated.

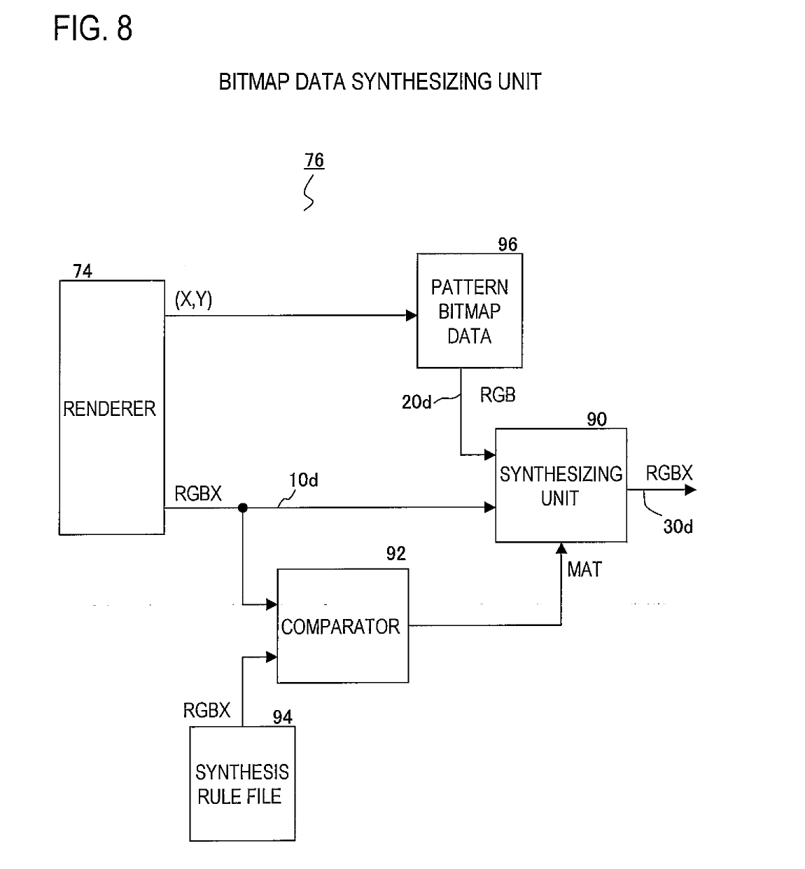

FIG. 8 is a schematic diagram of a bitmap data synthesizing unit of the present embodiment. FIG. 8 shows a specific hardware configuration. The bitmap data synthesizing unit 76 supplied with normal image data 10d bitmap-expanded by the renderer 74 as pixel unit data (RGB denotes color information and X denotes attribute information). A comparator 92 checks whether or not this pixel data RGBX matches synthesis rule file data in which the first combination data is stored and, if it matches, sets a match signal MAT to an H level and, if it is second combination data which constitutes those cases other than first combination data, sets the match signal MAT to a L level.

On the other hand, design bitmap data 96 such as of a latent image that constitutes one type of auxiliary image is already stored in the image-processing unit or it is expanded from an intermediate code. The auxiliary image data 20d is read out from the design bitmap data 96 in accordance with the pixel position (X, Y) of the normal image data. When the match signal MAT is the H level, a synthesizer 90 substitutes the color information of the normal image data 10d with the color information of the auxiliary image data 20d and outputs the synthesized image data 30d. When the match signal MAT is the L level, the color information of the normal image data 10d is not substituted with the color information of the auxiliary image data 20d and is output unchanged as the synthesized image data 30d. This synthesized image data 30d is written in the buffer memory.

The comparator 92 comprises a data matching function and, because the synthesizer 90 comprises only a function for selection based on the match signal MAT, it can be configured from a comparatively simple hardware circuit.

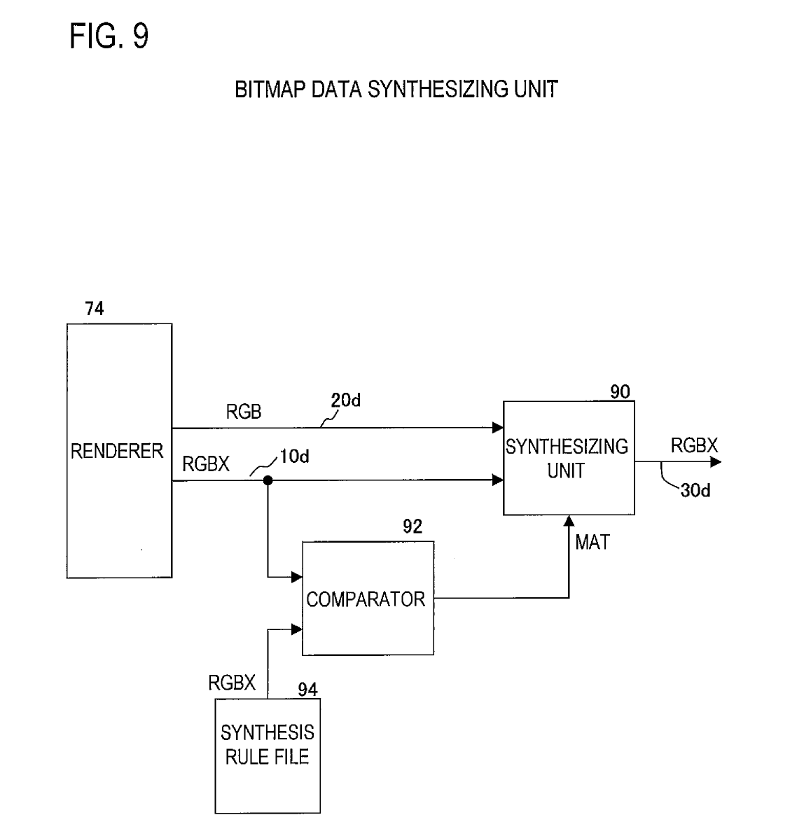

FIG. 9 is another schematic diagram of the bitmap data synthesizing unit of the present embodiment. This example comprises a synthesizer 90, a comparator 92 and a synthesis rule file 94 which are same to them in FIG. 8. The pixel data of the normal image data 10d and the pixel data of the auxiliary image data 20d bitmap-expanded by the renderer 74 are synchronously supplied. Thereupon, when the normal image data has the first combination, the comparator 92 sets the match signal MAT to the H level, and when it has the second combination which constitutes cases other than this, it sets the match signal MAT to the L level. The synthesizer 90 performs synthesizing processing on the basis of this match signal MAT in which the color information of the normal image data has either been substituted or not substituted with the color information of the auxiliary image data, and in which it outputs the synthesized image data 30d.

As is described above, the bitmap data synthesizing unit of the present embodiment can be configured from a synthesizing processing program, and it can be configured from a special hardware circuit.

### Second Embodiment

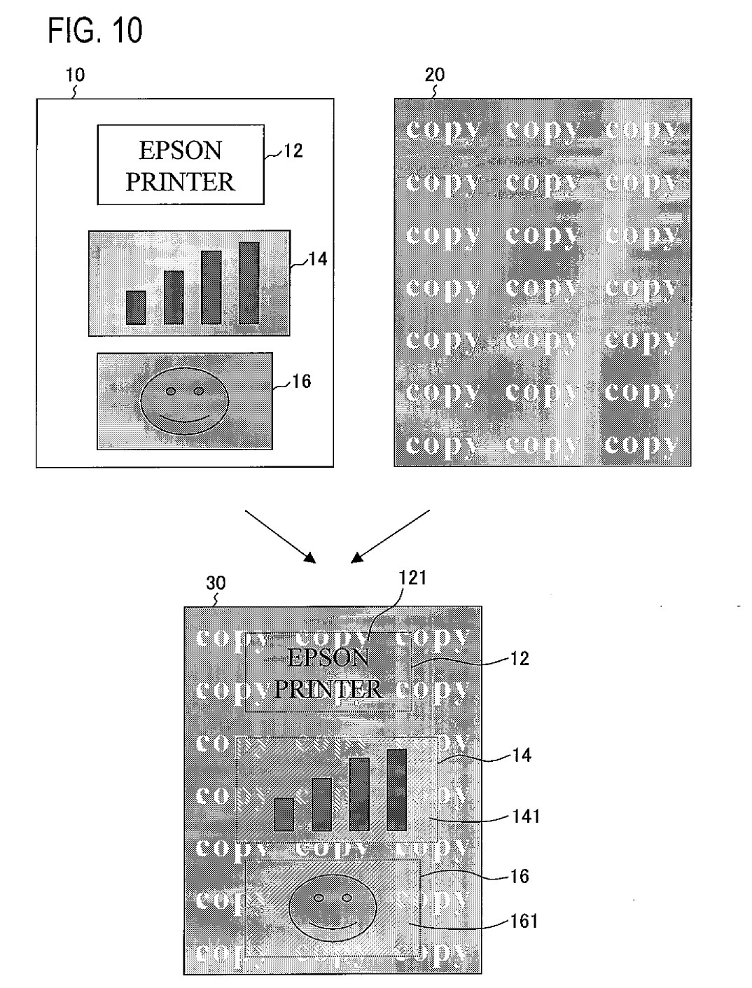

FIG. 10 is a diagram of an example of synthesized image data of a second embodiment. In this synthesizing example, a synthesized image 30 is generated as a result of the blend processing of the normal image 10 and auxiliary image 20. Blend processing is as one example, alpha blending which constitutes a processing in which image data to be overwritten is multiplied by an opacity a (0≦α≦1), the original image data is multiplied by (1−α), and the image data formed by the addition of the two is taken as the new image data. A desired blend processing can be achieved by the appropriate selection of the blending ratio. The synthesized image 30 is, to an extent, the result of the OR processing of two images 10, 20.

In this way, the image forming apparatus 70 of FIG. 4 is useful for the blend processing of two image data. In other words, whatever the print data 65 described by any PDL, two image data are bitmap-expanded using renderers 74 respectively correspondent thereto. The blend processing of the two bitmap data is performed for each pixel by the synthesizing unit 76. Because the blend processing is performed between bitmap data, printing of the synthesized image is possible irrespective of the PDL type.

By variously determining whether the blend processing described above is performed or not in accordance with the image attribute information and color information of the normal image data, an image synthesizing function with improved flexibility can be provided. For example, synthesizing processing in which a blend processing is performed in a certain combination of the two information and is not performed in other assemblies becomes possible. Accordingly, the image synthesizing function of the image forming apparatus 70 can be widely utilized with a plurality of users utilizing different PDL.

The explanation of the embodiments described above is based on an example in which two images are superimposed. However, these embodiments can have similar application in the superimposing processing of three or more images.

What is claimed is:

1. An image processing apparatus for generating a synthesized image in which an auxiliary image is superimposed on a normal image, comprising:
an image data synthesizing unit to which normal image data comprising color information and image attribute information correspondent to pixels bitmap-expanded from said normal image and auxiliary image data comprising at least color information correspondent to pixels bitmap-expanded from said auxiliary image are supplied,
and which generates synthesized image data for each pixel by synthesizing pixel data of said normal image data and pixel data of said auxiliary image data based on said color information and image attribute information of said normal image data.

2. The image processing apparatus according to claim 1,
wherein said image data synthesizing unit synthesizes the two data by substituting said color information of said auxiliary image data for said color information of said normal image data in a case that a combination of said color information and image attribute information of said normal image data is a first combination, and without substituting said color information of said auxiliary image data for said color information of said normal image data in a case that a combination of said color information and image attribute information of said normal image data is a second combination.

3. The image processing apparatus according to claim 1,
wherein said image data synthesizing unit synthesizes the two data by blend-processing said color information of said normal image data and said color information of said auxiliary image data in a predetermined blending ratio in a case that a combination of said color information and image attribute information of said normal image data is a first combination, and without substituting said color information of said auxiliary image data for the color information of said normal image data in a case that a combination of said color information and image attribute information of said normal image data is a second combination.

4. The image processing apparatus according to claim 2,
wherein said image data synthesizing unit does not change said image attribute information of said normal image data and outputs said information as image attribute information of said synthesized image data.

5. The image processing apparatus according to claim 2,
wherein said image attribute information includes at least a character, a graphic and a picture,
said first combination comprising one or both of a combination in which said color information is white or a color close thereto and said image attribute information is a graphic and a combination in which said color information is the same color as the color information of the auxiliary image data or a color close thereto and said image attribute information is a graphic, and said second combination comprising a combination that does not include said first combination.

6. The image processing apparatus according to claim 1,
wherein said auxiliary image comprises a latent image having an output density when copied from said latent image formed based on said synthesized image data, higher than an output density in a state prior to copying.

7. An image forming apparatus for printing a synthesized image in which an auxiliary image is superimposed on a normal image, comprising:
an image processing unit comprising a renderer which generates normal image data comprising color information and image attribute information correspondent to pixels bitmap-expanded from said normal image based on normal image print data described in a predetermined print language, and an image data synthesizing unit to which auxiliary image data comprising at least color information correspondent to pixels bitmap-expanded from said auxiliary image and said normal image data are supplied, and which generates synthesized image data for each pixel by synthesizing pixel data of said normal image data and pixel data of said auxiliary image data; and
a print engine which prints images based on said synthesized image data generated by said image processing unit.

8. The image forming apparatus according to claim 7,
wherein said image data synthesizing unit blend-processes said color information of the pixel data of the two image data at a predetermined blending ratio.

9. An image processing program for generating a synthesized image in which an auxiliary image is superimposed on a normal image,
the program causing a computer to configure an image data synthesizing unit to which normal image data comprising color information and image attribute information correspondent to pixels bitmap-expanded from said normal image and auxiliary image data comprising at least color information correspondent to pixels bitmap-expanded from said auxiliary image are supplied, and which generates synthesized image data for each pixel by synthesizing pixel data of said normal image data and pixel data of said auxiliary image data based on said color information and image attribute information of said normal image data.
